(19) United States
(12) Patent Application Publication
(10) Pub. No.: US 2008/0060829 A1
(43) Pub. Date: Mar. 13, 2008

(54) TOOTHBRUSH SANITIZATION SYSTEM

(76) Inventor: John M. Jansheski, Maryville, TN (US)

Correspondence Address: LUEDEKA, NEELY & GRAHAM, P.C., P O BOX 1871, KNOXVILLE, TN, 37901, US

(21) Appl. No.: 11/534,076

(22) Filed: Sep. 21, 2006

Related U.S. Application Data
(63) Continuation-in-part of application No. 11/530,057, filed on Sep. 8, 2006.

(51) Int. Cl. H01B 7/00

(52) U.S. Cl. 174/47

(57) ABSTRACT

A portable toothbrush sanitization system. The system includes a toothbrush, one or more sources of UV light operable by the electrical circuit for applying UV light to bristles of the toothbrush; and a cap configured to be installed on the toothbrush. The sources of UV light are operable only when the cap is installed on the toothbrush.

### CROSS-REFERENCE TO RELATED APPLICATIONS

This application is a continuation-in-part of co-pending application Ser. No. 11/530,057 filed Sep. 8, 2006, and entitled “Self-Sanitizing Toothbrush,” and co-pending application Ser. No. 11/530,060 filed Sep. 8, 2006, and entitled “Lighted Toothbrush.”

### FIELD

This invention relates to the field of toothbrush sanitization. More particularly, this invention relates to sanitization systems for individual toothbrushes that are portable and convenient for travel.

### BACKGROUND

Regular sanitization of a toothbrush is desirable to kill harmful germs and bacteria often found on toothbrushes, including streptococcus, E. coli and salmonella. Ultraviolet light sanitizers are known for this purpose, but, are provided as electrical devices configured to hold or store one or more toothbrushes and expose the toothbrushes to ultraviolet light. Such devices typically require counter space and an electrical outlet. Such devices are inconvenient for travel. What is desired is a sanitization system for individual toothbrushes that is portable and convenient for travel.

### SUMMARY

The above and other needs are met by a portable toothbrush sanitization system.

The system includes a toothbrush having bristles and an electrical circuit having a battery contained within a body portion of the toothbrush, with the toothbrush including a first electrical contact thereon and one or more sources of UV light operable by the electrical circuit for applying UV light to the bristles for sanitizing the bristles. The system also includes a cap configured to be installed on the toothbrush to engage a portion of the toothbrush to substantially enclose the bristles to shield locations exterior to the cap from the light from the UV light sources and including a second electrical contact thereon. When the cap is installed on the toothbrush the first electrical contact and the second electrical contact are placed in electrical communication so as to enable the electrical circuit to supply electrical power to the sources of UV light. The sources of UV light are operable only when the cap is installed on the toothbrush.

In one embodiment, the sources of UV light are located on the toothbrush.

In another embodiment, the sources of UV light are located on the cap.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is an exploded perspective view of a toothbrush sanitization system according to one embodiment of the disclosure.

FIG. 2 is a perspective view of a cap component of the sanitization system of FIG. 1.

FIG. 3 is a schematic of an electrical circuit used in the sanitization system of FIG. 1.

FIGS. 4 and 5 are perspective views showing a sanitization system according to an alternate embodiment of the disclosure.

### DETAILED DESCRIPTION

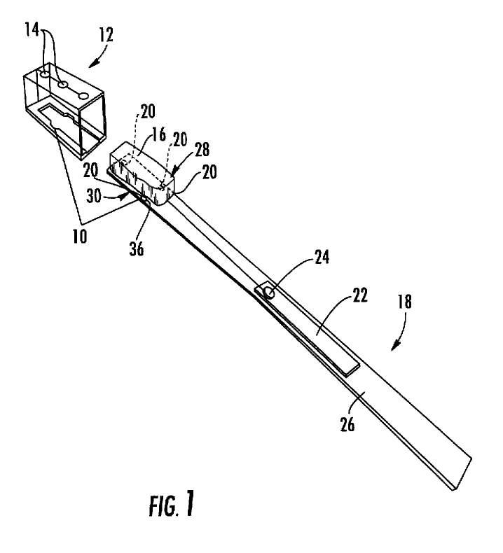

With reference to FIGS. 1-3, the disclosure relates to a toothbrush sanitization system 10 which includes a cap 12 having one or more ultraviolet (UV) light sources 14 configured to direct ultraviolet light to bristles 16 of a toothbrush 18 to sanitize the bristles 16 between uses. The bristles 16 are made of nylon or other conventional toothbrush bristle material and it has been observed that such materials may be readily sanitized by exposure to UV light.

The ultraviolet light sources 14 are preferably light emitting diodes capable of producing ultraviolet light in the wavelength range of from about 100 nanometers to about 280 nanometers, known as UV-C. UV-C light is germicidal in that it damages the nucleic acid of microorganisms such as bacteria, viruses and other pathogens to destroy their ability to multiply and cause disease.

The toothbrush 18 is configured to include one or more illumination sources 20 to direct illuminating light to locations adjacent the bristles 16 to illuminate the sites being brushed. In this regard, the toothbrush 18 includes an electrical circuit 22 operated by a switch 24 to enable a user to selectively activate the illumination sources 20. The illumination sources 20 are preferably light emitting diodes capable of producing white (visible) light. One or more batteries associated with the circuit 22 provide a source of electrical energy to power the ultraviolet light sources 14 when the cap 12 is installed on the toothbrush 18 after use thereof.

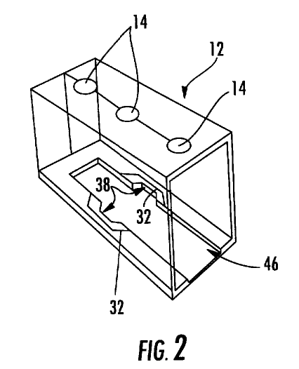

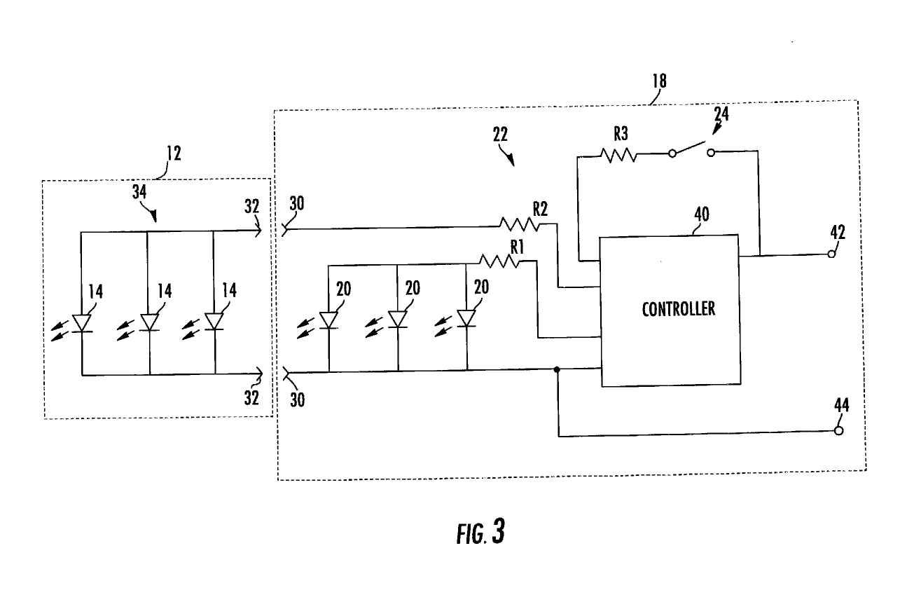

The toothbrush 18 includes a one-piece body of molded plastic construction and may be constructed by molding a handle portion 26 thereof around the circuit 22, leaving the switch 24 exposed. A head portion 28 of the toothbrush is also molded around the bases of the bristles 14, the illumination sources 20 and associated circuit components, leaving the illumination sources 20 partially exposed to emit light in the direction of the bristles 16. In preferred embodiments, the head portion 28 includes contacts 30 exposed for contacting corresponding contacts 32 of a circuit 34 (FIGS. 2 and 3) associated with the cap 12 when the cap 12 is installed on the toothbrush 18. In this regard, the head portion 28 is preferably slightly enlarged at the locations of the contacts 30 on both sides of the head portion 28 so as to provide engagement surfaces 36 for being received by corresponding receivers 38 of the cap 12 to frictionally retain the cap 12 installed on the toothbrush 18 and maintain the contacts 30 and 32 in abutting contact. For example, the engagement surfaces 36 may be located on opposite sides of the head portion 28, and the contacts 30 may be provided as by conductive material on edge portions of the engagement surfaces 36 in electrical communication with portions of the circuit 22 within the toothbrush 18. Likewise, the contacts 32 may be provided as by conductive material on edge portions of the receivers in electrical communication with portions of the circuit 34 located within the cap.

With reference to FIG. 3, there is shown a schematic diagram of a preferred embodiment of the electrical circuit 22 for controlling activation of the illumination sources 14 and 20. In this regard, the circuit 22 is desirably configured such that a user, prior to use of the toothbrush 18 to brush teeth, may press the switch 24 to illuminate the illumination sources 20. The circuit 22 is configured to activate the illumination sources 20 for a predetermined period of time corresponding to a desired brushing interval sufficient for effectively cleaning the teeth and then deactivating the illumination sources 20. This is advantageous to indicate to a user whether or not a sufficient brushing interval has been performed. This feature is particularly advantageous for training children in proper brushing techniques. The circuit 22 is shown integrated with the circuit 34 for enabling operation of the ultraviolet light sources 14 when the cap 12 is installed on the toothbrush 18.

In preferred embodiments, the circuit 22 includes a microprocessor controller 40 that operates in conjunction with the switch 24. The controller 40 activates the illumination sources 20 when the switch 24 is pressed and automatically shuts off the illumination sources 20 after a predetermined time to conserve battery power and to indicate when the desired brushing interval has elapsed. The controller 40 also controls the time of operation of the light sources 14 when the cap 12 is installed on the toothbrush 18. A suitable time for operation of the illumination sources 20 and/or the sources 14 as controlled by the controller 40 is about three minutes. Positive and negative battery terminals 42 and 44 are provided for connection of one or more small batteries also located within the handle portion 26. As noted previously, the batteries associated with the circuit 22 also provide power for the circuit 34 when the cap 12 is installed on the toothbrush 18.

Returning now to FIG. 2, the cap 12 is preferably of molded plastic construction, made of a UV-blocking plastic, and defines a chamber for enclosing the head portion 28 of the toothbrush 18 including the bristles 16, so as to shield locations exterior to the cap from the light from the ultraviolet light sources 14. As noted previously, the cap 12 includes the receivers 38 which are configured to engage the engagement surfaces 36 of the head portion 28 of the toothbrush 18. The interior of the cap 12 is preferably coated with a reflective finish. The ultraviolet light sources 14 are located on interior portions of the cap 12 do direct UV light onto the bristles 16 for sanitizing the bristles 16. For example, the ultraviolet light sources may be located along an upper ceiling portion over the bristles 16 or along the sides, or both.

To install the cap 12 onto the toothbrush 18, the head portion 28 of the toothbrush 18 may be slid into the cap 12, or vice versa, and the receivers 38 of the cap 12 receive the engagement surfaces 36 of the head portion 28 of the toothbrush 18. In this regard, the receivers 38 and surfaces 36 are preferably sized so that a small degree of force must be supplied by the user to seat the head portion 28 within the cap 12. This serves to frictionally retain the head portion 28 within the cap 12 and also provide tension to urge the contacts 30 of the circuit 22 associated with the toothbrush 18 against the contacts 32 of the circuit 34 associated with the cap 12. This slight tension helps to maintain good electrical contact. In this regard, the cap 12 also preferably defines a channel 46 configured for closely receiving the head portion 28. As will be noted, when the contacts 30 and 32 are in electrical communication, the circuit 34 is closed thereby activating the controller 40 to illuminate the ultraviolet light sources 14 for the predetermined period of time. If the cap 12 is removed from the head portion 28, the UV light sources 14 are deactivated.

Accordingly, the circuits 22 and 34 are configured to illuminate the ultraviolet light sources 14 when the cap 12 is installed. The circuits 22 and 34 may turn on the sources 14 immediately when the cap 12 is installed and then automatically turn the sources 14 off after a predetermined period of time sufficient for effectively sanitizing the bristles 16, such as five minutes. This is advantageous to conserve battery resources. Likewise, the cap 12 must be installed on the toothbrush 18 for the UV light sources 14 to operate. Thus, in the event that the toothbrush 18 is removed from the cap 12 while the ultraviolet light sources 14 are activated, the circuit 34 will be opened and the UV sources 14 will not operate. Since the ultraviolet light sources 14 are only operable when the cap 12 is installed, a user is shielded from exposure to ultraviolet light from the sources 14.

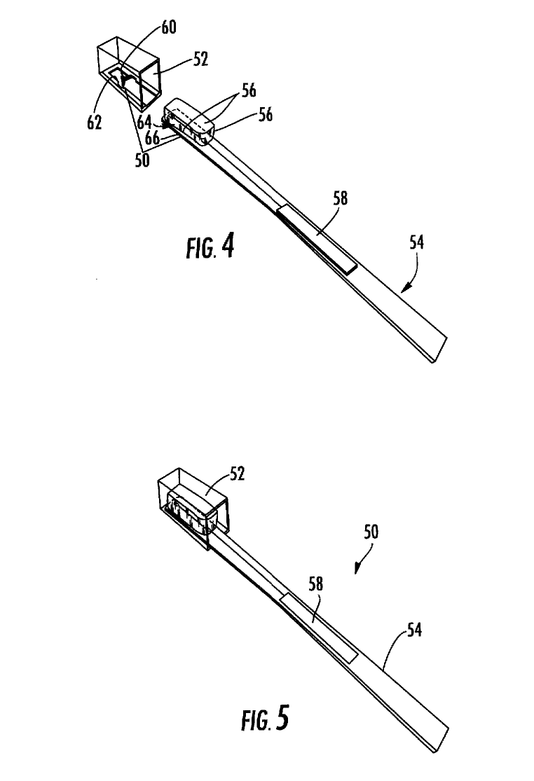

With reference now to FIGS. 4 and 5, there is shown an alternative embodiment of a sanitization system 50. The system 50 includes a cap 52 that is substantially similar to the cap 12, except that it does not include the illumination sources 14. The system 50 also includes a toothbrush 54 that is substantially similar to the toothbrush 18, except that it includes ultraviolet light sources 56 instead of the white-light illumination sources 20. A circuit 58 is located within the toothbrush 56 in the manner of the circuit 22, except that the circuit 58 does not include a switch corresponding to the switch 24. Rather, the system 50 is configured so that when the cap 52 is installed on the toothbrush 54, in a manner similar to that described above for installation of the cap 12 onto the toothbrush 18, the ultraviolet light sources 56 are illuminated for a predetermined period of time to effect sanitization of bristles of the toothbrush 54. In this regard, the cap 52 includes receivers 60 and contacts 62 corresponding to the receivers 38 and contacts 30 described in connection with the system 10, and a head portion of the toothbrush 54 includes engagement surfaces 64 and contacts 66 corresponding to the engagement surfaces 36 and contacts 32 described in connection with the system 10.

The foregoing disclosure has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A portable toothbrush sanitization system, the system comprising:
a toothbrush having bristles and an electrical circuit having a battery contained within a body portion of the toothbrush, with the toothbrush including a first electrical contact thereon;
one or more sources of UV light operable by the electrical circuit for applying UV light to the bristles for sanitizing the bristles; and
a cap configured to be installed on the toothbrush to engage a portion of the toothbrush to substantially enclose the bristles to shield locations exterior to the cap from the light from the UV light sources and including a second electrical contact thereon,
wherein when the cap is installed on the toothbrush the first electrical contact and the second electrical contact are placed in electrical communication so as to enable the electrical circuit to supply electrical power to the sources of UV light, and
wherein the sources of UV light are operable only when the cap is installed on the toothbrush.

2. The system of claim 1, wherein the sources of UV light emit UV-C light having a wavelength of from about 100 to about 280 nanometers.

3. The system of claim 1, wherein the sources of UV light are located on the toothbrush.

4. The system of claim 1, wherein the sources of UV light are located on the cap.
